(19) United States
(12) Patent Application Publication
(10) Pub. No.: US 2024/0280358 A1
(43) Pub. Date: Aug. 22, 2024

(54) ONLINE HIGH-PRECISION MEASURING DEVICE AND METHOD FOR FULL-SIZE PARAMETERS OF WHEEL SET OF RAIL TRANSIT VEHICLE

(71) Applicant: NSH-CTI Machine Tool (Jiangxi) Co., Ltd., Nanchang (CN)

(72) Inventors: Haiquan ZHOU, Nanchang (CN); Youle PENG, Nanchang (CN); Desheng ZHU, Nanchang (CN); Xi JIANG, Nanchang (CN); Wenjin ZHOU, Nanchang (CN); Jincheng ZHOU, Nanchang (CN); Fangbo WU, Nanchang (CN)

(73) Assignee: NSH-CTI Machine Tool (Jiangxi) Co., Ltd., Nanchang (CN)

(21) Appl. No.: 18/192,635

(22) Filed: Mar. 29, 2023

(30) Foreign Application Priority Data
Feb. 21, 2023 (CN) 202310145376.0

(51) Int. Cl. G01B 11/24; B61K 9/12

(52) U.S. Cl. CPC G01B 11/24; B61K 9/12

(57) ABSTRACT

An online high-precision measuring device for full-size parameters of a wheel set of a rail transit vehicle, includes: a first laser sensor, a second laser sensor, a third laser sensor, and a polygon measuring module that are configured to measure multiple parts of the wheel set. The first laser sensor is arranged on an inner side of a track at a certain angle. The second laser sensor is arranged below the track at a certain angle. The third laser sensor is arranged on an outer side of the track at a certain angle. The polygon measuring module is butted with the track. The device can realize online pass-through non-stop measurement of the full-size parameters of the wheel set of the rail transit train accurately, such as tread wear, equivalent conicity and wheel polygon.

### CROSS-REFERENCE TO RELATED APPLICATIONS

This application claims priority to Chinese Patent Application No. 202310145376.0 with a filing date of Feb. 21, 2023. The content of the aforementioned applications, including any intervening amendments thereto, is incorporated herein by reference.

### TECHNICAL FIELD

The present disclosure relates to the technical field of online detection and measurement of geometric shape and parameters of wheel sets of rail transit vehicles, and in particular, to an online high-precision measuring device and method for full-size parameters of a wheel set of a rail transit vehicle.

### BACKGROUND

The wheel set, as a core component of the rail transit train, plays an important role in carrying, guiding, traction and braking. Chinese rail transit has the characteristics of large speed range, wide region and complex line conditions. The wheel wear always exists, and the equivalent conicity and wheel polygon overrun of the wheel set often occur. The wheel wear affects the running stability and comfort of rail transit trains, and the equivalent conicity and wheel polygon overrun of the wheel set cause snake instability and high frequency vibration and even lead to wheel damage, which directly endangers the safety and reliability of trains. Therefore, it is very important to grasp the full-size status of the wheel set timely and accurately for the safe running of rail transit trains.

The tread wear, equivalent conicity and wheel polygon of the wheel set can be obtained through computer calculation by accurately obtaining the tread profile, inner distance, diameter and tread bouncing of the two wheels of the wheel set.

The existing measurement methods are mainly as follows. First, the wheel sets are measured one by one by manually operating several hand-held measuring instruments or small mobile measuring equipment, and the measured values are input into the computer for calculation to obtain the results. However, the manual operation of hand-held measuring instruments or small mobile measuring equipment is time-consuming and inefficient, is greatly affected by human operation factors, and has insufficient measurement stability. The to-be-measured train needs to stop for a long time, resulting in the reduction of train utilization rate and poor economy. Second, the wheel sets are measured with the measuring device of the under floor wheel lathe when the train is subjected to the wheel lathing work, and the results are obtained through the computer calculation of the under floor wheel lathe itself. However, the method of measuring the wheel sets with the measuring device of the under floor wheel lathe requires the whole measuring process to be carried out during the wheel lathing of the train. Such a method is time-consuming and inefficient, such that the on-line pass-through non-stop detection cannot be realized, and the full coverage detection of a large number of trains cannot be carried out in a short time. Third, dynamic measurement and qualitative judgment are carried out by using the dynamic detection system for the outline dimension of the trackside wheel and the online polygon detection system. However, the method for dynamic measurement using the dynamic detection system for the outline dimension of the trackside wheel and the online polygon detection system has low measurement accuracy and large error. The measurement accuracy of the equivalent conicity of the wheel set cannot meet the relevant requirements. The wheel polygon can only be detected qualitatively, and the accurate amplitude of wheel polygon cannot be measured accurately.

Therefore, how to provide an online high-precision measuring device and method for full-size parameters of a wheel set of a rail transit vehicle, which is convenient and efficient, has high degree of automation and measurement accuracy, has functions of measuring the equivalent conicity and wheel polygon of the wheel set, and can achieve non-stop measurement has become an urgent problem to be solved by those skilled in the art. Therefore, the present disclosure provides a novel online high-precision measuring device and method for full-size parameters of a wheel set of a rail transit vehicle, which can effectively solve the above problems.

### SUMMARY OF PRESENT INVENTION

A technical problem to be solved by the present disclosure is to provide a novel online high-precision measuring device and method for full-size parameters of a wheel set of a rail transit vehicle, aiming at the problem that existing equipment and method cannot grasp a full-size status of the wheel set effectively.

To solve the above technical problem, embodiments of the present disclosure provide an online high-precision measuring device for full-size parameters of a wheel set of a rail transit vehicle, including: a first laser sensor, a second laser sensor, a third laser sensor, and a polygon measuring module.

The first laser sensor is configured to measure data of an inner distance of a to-be-measured wheel set and is arranged on an inner side of a track bearing the wheel set.

The second laser sensor is configured to measure data of a profile of a tread of the wheel set and is arranged below the track. The track is provided with a slit for passage of a laser emitted by the second laser sensor.

The third laser sensor is configured to measure data of an axle lower profile of the wheel set and is arranged on an outer side of the track.

The polygon measuring module is butted with the track and is configured to measure a radial runout value of the tread of the wheel set.

The polygon measuring module includes a floating probe, and the floating probe is supported by a spring to float up and down, and maintains contact with the tread of the wheel set, such that the radial runout value of the tread of the wheel set is determined.

Preferably, the polygon measuring module further includes a guide rail and a displacement sensor. The guide rail is a main supporting structure of the polygon measuring module, and is butted with the track to support movement of the wheel set and provide guidance. The displacement sensor is configured to measure an up and down floating distance of the floating probe.

Preferably, a distance between a contact point of the floating probe and the tread of the wheel set and an inner side surface of a wheel in the wheel set is ΔL=70 mm.

Preferably, the first laser sensor, the second laser sensor and the third laser sensor each are provided with two laser sensing devices. The two laser sensing devices are symmetrically distributed along a center line of the track.

Preferably, the first laser sensor, the second laser sensor and the third laser sensor each are arranged on the track at a certain angle, and remains relatively static with the track.

Preferably, the first laser sensor, the second laser sensor and the third laser sensor each are provided with a wheel sensor configured to detect whether the wheel set reaches a measuring position.

The present disclosure further provides an online high-precision measuring method for full-size parameters of a wheel set of a rail transit vehicle, using the above measuring device, and including:
S100: measuring and storing the data of the inner distance of the wheel set using the first laser sensor, and measuring and storing the data of the profile of the tread of the wheel set using the second laser sensor;
S200: processing the measured data of the inner distance and the profile, and calculating an equivalent conicity;
S300: measuring and storing the data of the axle lower profile of the wheel set using the third laser sensor;
S400: calculating a spatial height position of a center of an axle of the wheel set relative to an upper surface of the track through algorithm analysis, so as to calculate a wheel diameter of the wheel set;
S500: rolling the wheel set from the polygon measuring module to make the floating probe contact with the tread of the wheel set, so as to measure the radial runout value of the tread;
S600: calculating a wheel polygon value of the wheel set through algorithm analysis according to the measured wheel diameter and radial runout value; and
S700: outputting a data report of the profile, the wheel diameter, the equivalent conicity, and the wheel polygon value.

Preferably, in S100 and S300, the first laser sensor, the second laser sensor and the third laser sensor each are provided with a wheel sensor at a measuring position, and the wheel sensor is configured to detect whether the wheel reaches the measuring position.

Preferably, in S100 and S300, the first laser sensor, the second laser sensor and the third laser sensor do not move with the wheel set, and remain relatively static.

Preferably, in S500, the up and down floating distance of the floating probe is determined using the displacement sensor, and the radial runout value of the tread of the wheel set is determined.

The embodiments of the present disclosure have the following beneficial effects:
(1) The online high-precision measuring device for full-size parameters of a wheel set of a rail transit vehicle of the present disclosure has high measurement accuracy and high degree of automation. In addition, the measurement process can be completed automatically without manual operation on site, to avoid the error caused by human factors.
(2) The online high-precision measuring device for full-size parameters of a wheel set of a rail transit vehicle of the present disclosure has high measurement efficiency and high integration. The measuring device can be installed at the throat track where the train passes at a high frequency, and in the whole online pass-through measuring process, the train can go without stopping. The accurate and quantitative measurement of the tread wear, equivalent conicity, and wheel polygon of all wheel sets can be completed by one pass of the train. The algorithm is convenient and the system response speed is high, which does not conflict with the train overhaul or wheel lathing operation, greatly improving the measurement efficiency and improving the efficiency of train overhaul.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and those of ordinary skill in the art may still derive other drawings from these accompanying drawings without creative efforts.

FIG. 1 is a schematic structural diagram of a measuring device according to a first embodiment provided by the present disclosure;

FIG. 2 is a structural schematic diagram of a measuring device provided by the present disclosure from another perspective;

FIG. 3 is a local structure diagram when a wheel set passes through a second laser sensor in the first embodiment provided by the present disclosure;

FIG. 4 is a local structure diagram when the wheel set passes through a polygon measuring module in the first embodiment provided by the present disclosure;

FIG. 5 is a schematic diagram of a micro-enlarged structure when the wheel set passes through the polygon measuring module in the first embodiment provided by the present disclosure; and

FIG. 6 is a flowchart of a measuring method in a second embodiment provided by the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

### Embodiment I

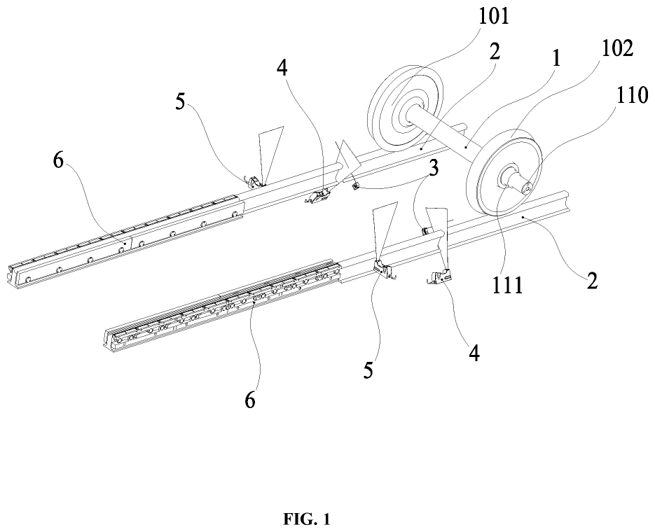

Referring to FIG. 1, a specific implementation of the present disclosure provides an online high-precision measuring device for full-size parameters of a wheel set of a rail transit vehicle. The online high-precision measuring device for full-size parameters of a wheel set of a rail transit vehicle includes a first laser sensor 3, a second laser sensor 4, a third laser sensor 5, and a polygon measuring module 6. The to-be-measured wheel set is a wheel set 1, and a track where the wheel set 1 runs is a track 2. The wheel set 1 includes an inner side surface 101, a tread 102, an axle 110, and an axle lower profile 111. The first laser sensor 3, the second laser sensor 4 and the third laser sensor 5 each are provided with two laser sensing devices. The two laser sensing devices are symmetrically distributed along a center line of the track 2, and remain relatively static with the track 2. The first laser sensor 3 is arranged on an inner side of the track 2 at a certain angle, and is configured to measure data of an inner distance of the to-be-measured wheel set. The second laser sensor 4 is arranged below the track 2 at a certain angle, and is configured to measure data of a profile of the tread 102 of the wheel set. The third laser sensor 5 is arranged on an outer side of the track 2 at a certain angle, and is configured to measure data of the axle lower profile 111. The polygon measuring module 6 is butted with the track 2, and is configured to measure a radial runout value of the tread 102 of the wheel set.

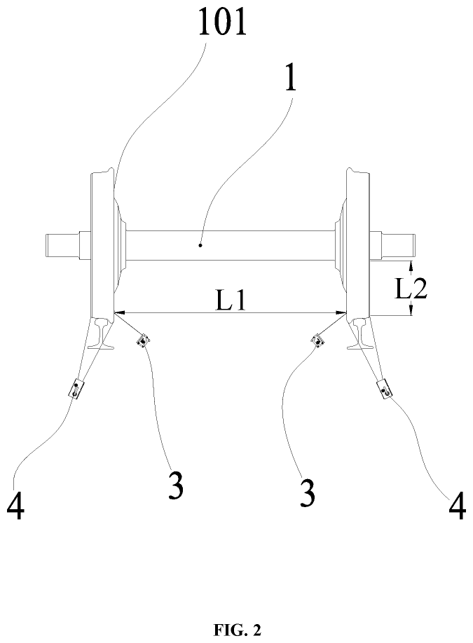

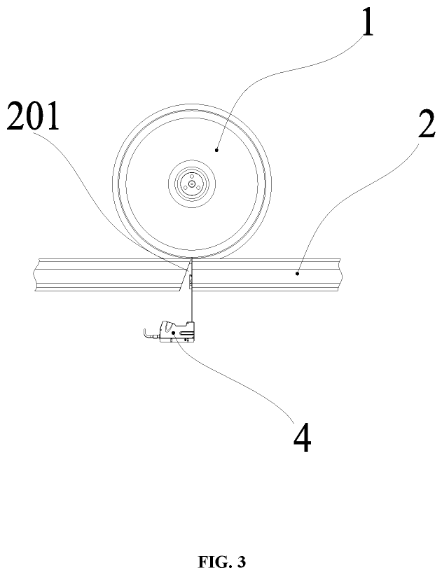

Referring to FIG. 2, the first laser sensor 3 irradiates the inner side surface 101 of the wheel set by emitting a laser beam, so as to determine specific positions of two laser sensing devices in the first laser sensor 3, a specific width of the track 2 and a deflection angle of the first laser sensor 3. By irradiating the inner side surface 101 of the wheel set with the laser beam, a specific distance from the first laser sensor to the inner side surface 101 of the wheel set is determined, such that the data of the inner distance L1 of the wheel set is determined. The second laser sensor 4 irradiates a laser beam on the tread 102 of the wheel set to determine the data of the profile of the tread 102 of the wheel set. Referring to FIG. 3, the track 2 is provided with a slit 201 directly above the second laser sensor 4. The laser beam emitted by the second laser sensor 4 irradiates the tread 102 of the wheel set through the slit 201. Referring to FIG. 1, the third laser sensor 5 is arranged on the outer side of the track 2, and can directly emit a laser beam to irradiate the axle lower profile 111 on the axle 110 of the wheel set to determine specific position data of the axle lower profile 111. Under the condition that the specific position of the third laser sensor 5 is clear, a spatial height distance L2 between the axle lower profile 111 and the upper surface of the track 2 can be determined. Further, under the condition that a radius of the axle 110 of the wheel set is clear, a spatial height position of a center of the axle 110 of the wheel set relative to the upper surface of the track 2 can be obtained, so as to calculate a wheel diameter of the wheel set 1.

The first laser sensor 3, the second laser sensor 4 and the third laser sensor 5 each are provided with a wheel sensor. After sensing the approaching of the wheel set 1, the first laser sensor 3, the second laser sensor 4 and the third laser sensor 5 start to work to ensure that other items are not detected, so as to prevent the existence of interference data in the stored data, and reduce energy consumption, which is more environmentally friendly.

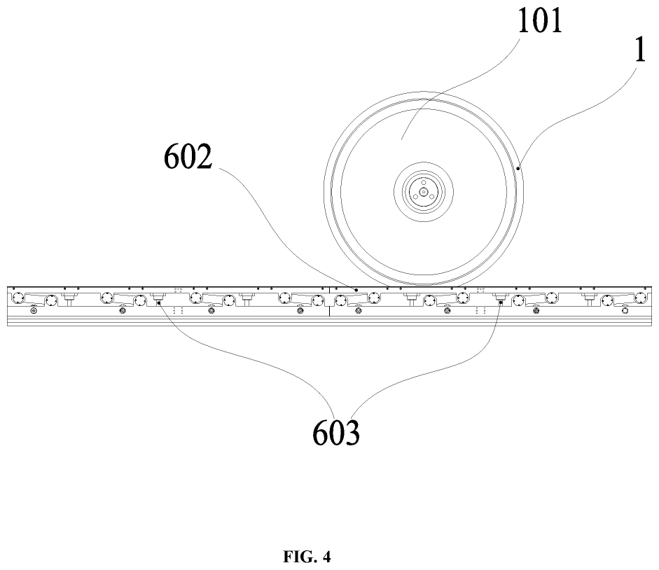

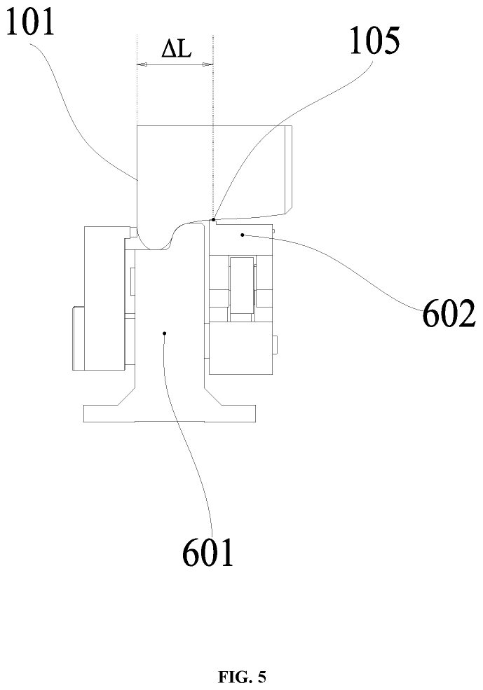

Referring to FIG. 4 and FIG. 5, the polygon measuring module 6 includes a guide rail 601, a floating probe 602 and a displacement sensor 603. The guide rail 601 is a main structure of the polygon measuring module 6, and is configured to support and guide the wheel set 1. The guide rail 601 is butted with the track 2. The floating probe 602 is arranged on the outer surface of the guide rail 601. The displacement sensor 603 and the floating probe 602 are parallel and are both arranged on the outer surface of the guide rail 601. The floating probe 602 is supported by a spring to float up and down. The floating probe 602 is always in contact with the tread 102 of the wheel set. The contact point is a standard measuring rolling circle 105. A distance between the standard measuring rolling circle 105 and the inner side surface 101 of the wheel set is ΔL=70 mm. The floating probe 602 floats up and down as the wheel set 1 runs, and the displacement sensor 603 is configured to measure a floating distance of the floating probe 602.

### Embodiment II

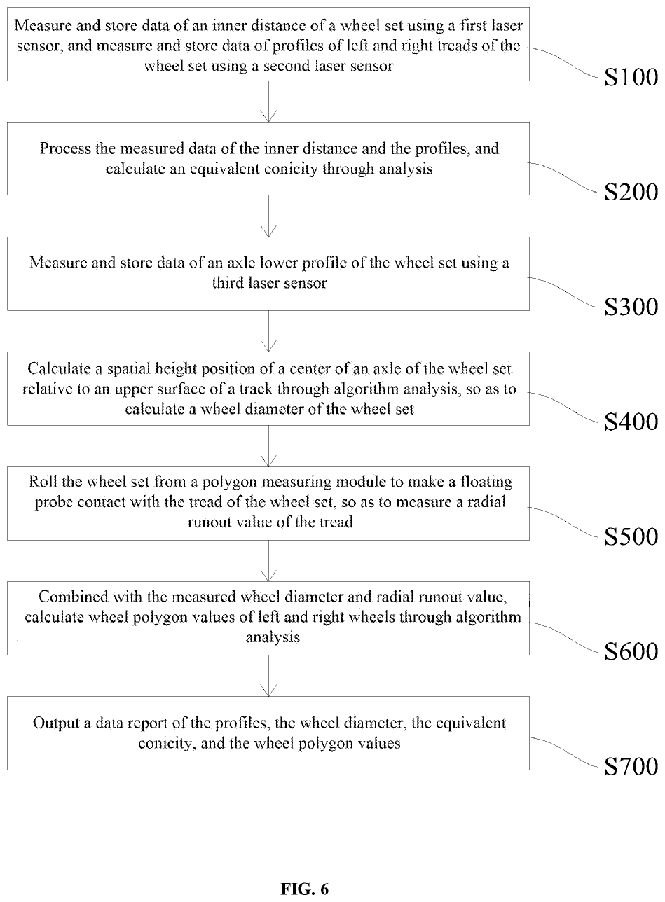

Referring to FIG. 6, based on Embodiment I, the present further provides an online high-precision measuring method for full-size parameters of a wheel set of a rail transit vehicle. The measuring method includes the following steps.
S100: The data of the inner distance of the wheel set is measured and stored using the first laser sensor, and the data of the profile of the tread of the wheel set is measured and stored using the second laser sensor.
S200: The measured data of the inner distance and the profile is processed, and an equivalent conicity is calculated.
S300: The data of the axle lower profile of the wheel set is measured and stored using the third laser sensor.
S400: A spatial height position of a center of an axle of the wheel set relative to an upper surface of the track is calculated through algorithm analysis, so as to calculate a wheel diameter of the wheel set.
S500: The wheel set is rolled from the polygon measuring module to make the floating probe contact with the tread of the wheel set, so as to measure the radial runout value of the tread.
S600: A wheel polygon value of the wheel set is calculated through algorithm analysis the according to measured wheel diameter and radial runout value.
S700: A data report of the profile, the wheel diameter, the equivalent conicity, and the wheel polygon value is output.

In S100 and S300, the first laser sensor, the second laser sensor and the third laser sensor each are provided with a wheel sensor at a measuring position, and the wheel sensor is configured to detect whether the wheel reaches the measuring position. According to the detection results, the data such as the inner distance, the profile and the axle lower profile is selectively stored. The first laser sensor, the second laser sensor and the third laser sensor do not move with the wheel set, and remain relatively static. In S500, the up and down floating distance of the floating probe is determined using the displacement sensor, and the radial runout value of the tread of the wheel set is determined.

The above disclosed is only a preferred embodiment of the present disclosure, and definitely should not be used to limit the scope of the claims of the present disclosure. Those of ordinary skill in the art can understand all or some of the procedures for implementing the foregoing embodiments and make equivalent changes according to the claims of the present disclosure. The equivalent changes still fall within the scope of the present disclosure.

What is claimed is:

1. An online high-precision measuring device for full-size parameters of a wheel set of a rail transit vehicle, comprising: a first laser sensor, a second laser sensor, a third laser sensor, and a polygon measuring module, wherein
the first laser sensor is configured to measure data of an inner distance of a to-be-measured wheel set and is arranged on an inner side of a track bearing the wheel set;
the second laser sensor is configured to measure data of a profile of a tread of the wheel set and is arranged below the track, wherein the track is provided with a slit for passage of a laser emitted by the second laser sensor;
the third laser sensor is configured to measure data of an axle lower profile of the wheel set and is arranged on an outer side of the track;
the polygon measuring module is butted with the track and is configured to measure a radial runout value of the tread of the wheel set; and
the polygon measuring module comprises a floating probe, and the floating probe is supported by a spring to float up and down, and maintains contact with the tread of the wheel set, such that the radial runout value of the tread of the wheel set is determined.

2. The measuring device according to claim 1, wherein the polygon measuring module further comprises a guide rail and a displacement sensor; the guide rail is a main supporting structure of the polygon measuring module, and is butted with the track to support movement of the wheel set and provide guidance; and the displacement sensor is configured to measure an up and down floating distance of the floating probe.

3. The measuring device according to claim 1, wherein a distance between a contact point of the floating probe and the tread of the wheel set and an inner side surface of a wheel in the wheel set is ΔL=70 mm.

4. The measuring device according to claim 1, wherein the first laser sensor, the second laser sensor and the third laser sensor each are provided with two laser sensing devices; and the two laser sensing devices are symmetrically distributed along a center line of the track.

5. The measuring device according to claim 3, wherein the first laser sensor, the second laser sensor and the third laser sensor each are arranged on the track at a certain angle, and remain relatively static with the track.

6. The measuring device according to claim 3, wherein the first laser sensor, the second laser sensor and the third laser sensor each are provided with a wheel sensor configured to detect whether the wheel set reaches a measuring position.

7. An online high-precision measuring method for full-size parameters of a wheel set of a rail transit vehicle, using the measuring device according to claim 1, and comprising:
S100: measuring and storing the data of the inner distance of the wheel set using the first laser sensor, and measuring and storing the data of the profile of the tread of the wheel set using the second laser sensor;
S200: processing the measured data of the inner distance and the profile, and calculating an equivalent conicity;
S300: measuring and storing the data of the axle lower profile of the wheel set using the third laser sensor;
S400: calculating a spatial height position of a center of an axle of the wheel set relative to an upper surface of the track through algorithm analysis, so as to calculate a wheel diameter of the wheel set;
S500: rolling the wheel set from the polygon measuring module to make the floating probe contact with the tread of the wheel set, so as to measure the radial runout value of the tread;
S600: calculating a wheel polygon value of the wheel set through algorithm analysis according to the measured wheel diameter and radial runout value; and
S700: outputting a data report of the profile, the wheel diameter, the equivalent conicity, and the wheel polygon value.

8. The measuring method according to claim 7, wherein in steps S100 and S300, the first laser sensor, the second laser sensor and the third laser sensor each are provided with a wheel sensor at a measuring position, and the wheel sensor is configured to detect whether the wheel reaches the measuring position.

9. The measuring method according to claim 7, wherein in steps S100 and S300, the first laser sensor, the second laser sensor and the third laser sensor do not move with the wheel set, and remain relatively static.

10. The measuring method according to claim 7, wherein in step S500, the up and down floating distance of the floating probe is determined using the displacement sensor, and the radial runout value of the tread of the wheel set is determined.
